(19) United States
(12) Patent Application Publication
(10) Pub. No.: US 2012/0315592 A1
(43) Pub. Date: Dec. 13, 2012

(54) TIERED FURNACE

(75) Inventors: Stefan Adelbert, Delbruck (DE); Otto Buschsieweke, Paderborn (DE); Martin Pohl, Altenbeken (DE)

(73) Assignee: Benteler Automobiltechnik GmbH, Paderborn (DE)

(21) Appl. No.: 13/314,671

(22) Filed: Dec. 8, 2011

(30) Foreign Application Priority Data
Dec. 9, 2010 (DE) DE 102010053979.1

(51) Int. Cl. F27B 1/10; C21D 9/00; F27D 3/00

(52) U.S. Cl. 432/239; 432/261

(57) ABSTRACT

A tiered furnace includes a plurality of decks in superimposed disposition for receiving flat or at least partly shaped plates which are made of steel. Each of the decks has at least one heater to thereby provide each deck with at least two heating zones that are operating at different temperatures.

### CROSS-REFERENCES TO RELATED APPLICATIONS

This application claims the priority of German Patent Application, Serial No. 10 2010 053 979.1, filed Dec. 9, 2010, pursuant to 35 U.S.C. 119(a)-(d), the content of which is incorporated herein by reference in its entirety as if fully set forth herein.

### BACKGROUND OF THE INVENTION

The present invention relates to a tiered furnace.

The following discussion of related art is provided to assist the reader in understanding the advantages of the invention, and is not to be construed as an admission that this related art is prior art to this invention.

U.S. Pat. No. 7,704,447 to Danger et al. describes a tiered furnace for heating steel plates, including a plurality of horizontal furnace levels in superimposed disposition. Each furnace level is constructed for acceptance of at least one steel plate and includes a transport mechanism for moving the at least one steel plate during a heating process.

It would be desirable and advantageous to provide an improved tiered furnace to obviate prior art shortcomings.

### SUMMARY OF THE INVENTION

According to one aspect of the present invention, a tiered furnace includes a plurality of decks in superimposed disposition for receiving flat or at least partly shaped plates of steel, and a plurality of heaters interacting with the decks in one-to-one correspondence to thereby provide each of the decks with at least two heating zones operating at different temperatures.

In accordance with the present invention, each deck of the tiered furnace has two heating zones by which the plates can be heated to different temperatures, thereby allowing at least one area of the plate to be quenched and tempered. For example, plates that are coated and commercially available under the designation USIBOR 1500 can be completely heated to about 900° C. to produce a desired diffusion layer. Subsequently, desired zone of the plates undergo a time-controlled decrease in temperature in order to attain the desired material properties during partial quenching and tempering. Such a measure renders the need for pre-alloying of the plates in an external furnace unnecessary. The heaters may be arranged in longitudinal or transverse direction of the plates.

According to another advantageous feature of the present invention, the heaters can be configured for control thereof.

According to another advantageous feature of the present invention, the heaters can be configured as inductive heat generators. Other examples of conceivable configurations as heaters are conductive heat generators, or open burners, or radiant heaters, or infrared heaters.

According to another advantageous feature of the present invention, an offset control may be operably connected to the heaters. In this way, the cycle time of the tiered furnace can be shortened. For that purpose, the respective heater has a significantly higher temperature than a target temperature of the plate to be heated. When the target temperature has been reached on the plate, the temperature of the heater is decreased rapidly enough to prevent the plate from absorbing any further heat energy so as to be maintained at the target temperature.

According to another advantageous feature of the present invention, a thermally insulating separator can be provided between the heating zones. As a result, at least an area of the plate can undergo a desired quenching and tempering process. As the separator can be configured adjustably, it is possible to reposition the separator during a product change.

According to another advantageous feature of the present invention, supports can be provided in the decks for spot support of the plates. As an alternative, supports may be provided in the decks for linear support of the plates. As a result of a spot support or linear support of the plates, contact of the surfaces of the plates with the bearing points in the decks of the tiered furnace can be kept to a minimum so that the presence of significant deposits of the coated plates, in particular of AISi deposits, are not encountered in the area of the spot or linear supports in view of the small contact areas. Thus, the quality of the plates is not adversely affected.

The supports of the plates may be formed by a plurality of pointed supports or support rails of different configuration depending on the shape of the respective plates. The spot and linear supports can be integrated directly in the decks of the tiered furnace.

The spot or linear supports may however also form parts of drawer elements which are provided in the decks. These drawer elements can thus be moved in relation to the tiered furnace in order to permit loading and unloading of plates. It is conceivable to configure the drawer elements for horizontal movement in both directions in and out of the tiered furnace for loading and unloading.

According to another advantageous feature of the present invention, provision may be made for at least one transfer device to load the plates in the decks or drawer elements and to unload the plates from the decks or drawer elements. This facilitates handling of the plates. The provision of one transfer device is normally sufficient when the plates or the drawer elements are inserted or removed from one side of the tiered furnace. However, the throughput rate can be increased when providing two transfer devices on opposite sides of the tiered furnace, respectively.

According to another advantageous feature of the present invention, each transfer device may be configured for movement in three spatial axes for automated supply or removal of plates to and from the tiered furnace.

According to another advantageous feature of the present invention, each transfer device can include spot or linear supports, for example in the form of pointed supports or linear support rails.

According to another advantageous feature of the present invention, the transfer device may be associated to a heating zone formed by one of the heaters. In this way, the temperature of a plate heated in the tiered furnace can be substantially retained also during a subsequent transport for hot forming.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective view of a tiered furnace according to the present invention, equipped with a transfer device;

FIG. 2 is a schematic perspective view of a deck of the tiered furnace of FIG. 1;

FIG. 3 shows different embodiments of supports for a plate;

FIG. 4 is a schematic perspective view of a drawer element for the tiered furnace of FIG. 1; and

FIG. 5 is a schematic perspective view of a variation of a drawer element for the tiered furnace of FIG. 1.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

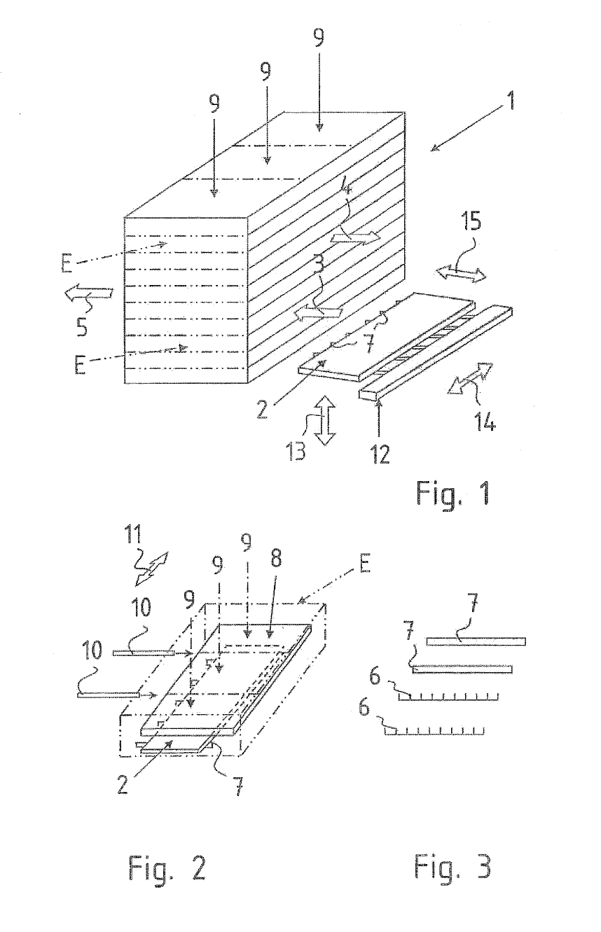

Turning now to the drawing, and in particular to FIG. 1, there is shown a schematic perspective view of a tiered furnace according to the present invention, generally designated by reference numeral 1 for heating flat or at least partly shaped blanks or plates 2 of steel. In the non-limiting example of FIG. 1, the tiered furnace 1 has ten levels or decks E placed on top of one another for respectively receiving plates 2.

Each deck E can be loaded with a plate 2 in a direction of arrow 3. After heated, the plate 2 can be removed from the same side in a direction indicated by arrow 4. Of course, it is conceivable to insert the plate 2 according to arrow 3 on one side and remove the heated bank 2 from the other side, as indicated by arrow 5.

As shown in FIGS. 2 and 3, the decks 5 of the tiered furnace 1 are provided with supports 6, 7 for the plates 2 in the form of pointed supports 6 (FIG. 3) or linear support rails 7. The number of supports 6, 7 and their configuration can be suited to the configuration of the plates 2 to be heated. As a result, the plates 2, in particular when coated plates 2 are involved, are only in slight contact with the pointed supports 6 or support rails 7.

Each deck E of the tiered furnace 1 is subdivided into at least two, in the non-limiting example shown here in FIG. 2 into three, heating zones 9 provided with heaters 8 and heated to different temperatures. The heaters 8 are controllable. Although not shown in detail, an offset control can be associated to the heaters 8. Currently preferred is a configuration of the heaters 8 as radiant heaters.

A thermally insulating separator 10 is provided between the heating zones 9, as shown in FIG. 2. The separators 10 can be shifted for repositioning, as indicated by double arrow 11 so as to be prevented from interfering with a change of plates.

Although not shown in detail, the heating zones 9 may also be arranged transversely to the blanks 2.

As can be further seen from FIG. 1, the tiered furnace 1 is equipped with a transfer device 12 for loading the decks E with plates 2 and unloading the plates 2 from the tiered furnace 1. As indicated by double arrows 13, 14, 15, the transfer device 12 can be moved in three spatial axes in vertical and horizontal directions. Also the transfer device 12 is provided with pointed supports 6 or linear support rails 7 according to FIG. 3 for the plates 2. For sake of simplicity, support rails 7 are only shown here.

The transfer device 12 allows the plates 2 to be shifted in each deck E of the tiered furnace 1 and placed onto the supports 6, 7, as shown in FIG. 2. After being heated, the plates 2 are withdrawn from the deck E by the transfer device 12 again. To prevent temperature loss of the plates 2, the transfer device 12 may be provided with a heater 8 similar to the illustration of FIG. 2. Subdivision of the transfer device 12 into heating zones 9 may, optionally, also be possible.

If need be, a further transfer device 12 may be provided also on the other side of the tiered furnace 1.

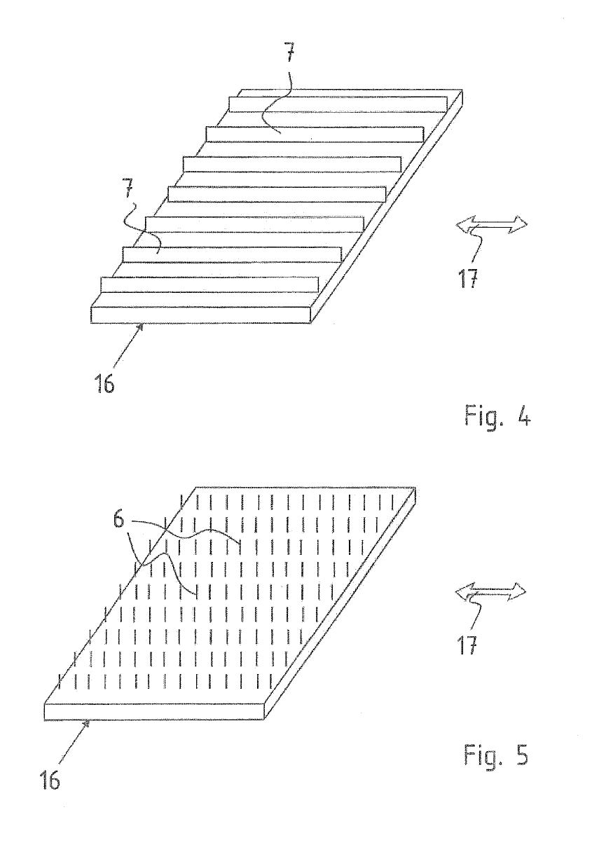

FIGS. 4 and 5 show two embodiments of drawer elements 16 which are provided in the decks E. The spot or linear supports 6, 7 may hereby form part of the drawer elements 16. As indicated by double arrow 17, the drawer elements 16 can be moved into or removed from the tiered furnace 1 on one side or both sides. A transfer device 12 may be provided to feed the drawer elements 16 outside of the tiered furnace 1 with plates 2 or to remove the plates 2 from the drawer elements 16.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A tiered furnace, comprising:
a plurality of decks in superimposed disposition for receiving flat or at least partly shaped plates of steel; and
a plurality of heaters interacting with the decks in one-to-one correspondence to thereby provide each of the deck with at least two heating zones operating at different temperatures.

2. The tiered furnace of claim 1, wherein the heaters are configured for control thereof.

3. The tiered furnace of claim 1, wherein the heaters are configured as inductive heat generators.

4. The tiered furnace of claim 1, wherein the heaters are configured as conductive heat generators.

5. The tiered furnace of claim 1, wherein the heaters are configured as open burners.

6. The tiered furnace of claim 1, wherein the heaters are configured as radiant heaters.

7. The tiered furnace of claim 1, wherein the heaters are configured as infrared heaters.

8. The tiered furnace of claim 1, further comprising an offset control operably connected to the heaters.

9. The tiered furnace of claim 1, further comprising a thermally insulating separator provided between the heating zones.

10. The tiered furnace of claim 9, wherein the separator is adjustable.

11. The tiered furnace of claim 1, further comprising supports provided in the decks for spot support of the plates.

12. The tiered furnace of claim 11, wherein the supports form part of drawer elements provided in the decks.

13. The tiered furnace of claim 1, further comprising supports provided in the decks for linear support of the plates.

14. The tiered furnace of claim 13, wherein the supports form part of drawer elements provided in the decks.

15. The tiered furnace of claim 1, further comprising at least one transfer device for loading the plates in the decks and unloading the plates from the decks.

16. The tiered furnace of claim 15, wherein the least one transfer device includes spot or linear supports.

17. The tiered furnace of claim 15, wherein the least one transfer device has a heater for establishing a heating zone.
